(19) United States
(12) Patent Application Publication
(10) Pub. No.: US 2012/0159541 A1
(43) Pub. Date: Jun. 21, 2012

(54) PLATFORM SHIFTED ADVERTISING AND INFORMATION FULFILLMENT

(76) Inventors: Owen A. Carton, Hillsborough, CA (US); Martha C. Carton, Hillsborough, CA (US); Andy J. Nelson, Orangevale, CA (US)

(21) Appl. No.: 13/330,882

(22) Filed: Dec. 20, 2011

Related U.S. Application Data
(60) Provisional application No. 61/424,864, filed on Dec. 20, 2010.

(51) Int. Cl. H04N 21/00

(52) U.S. Cl. 725/34

(57) ABSTRACT

Users are prompted to request more information via an on-screen message when viewing a television program, commercial, movie, or other video. If accepted by using a remote control or computer input device, the user receives related promotional or informational content to another device, such as a computer, smart-phone or tablet, or platform, such as a social network, for later consumption.

### CROSS-REFERENCE TO RELATED APPLICATIONS

This utility patent application claims priority from U.S. provisional patent application Ser. No. 61/424,864, filed Dec. 20, 2010, titled “PLATFORM SHIFTED ADVERTISING AND INFORMATION FULFILLMENT” in the name of OWEN A. CARTON, MARTHA C. CARTON, and ANDY J. NELSON.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2011, TeIIX, Inc.

### BACKGROUND OF THE INVENTION

1. Field of the Invention

This invention relates to video, and more particularly to interactive content and advertising delivery on-demand.

2. Description of Prior Art

Traditional television based video advertising in general provides information to audiences or consumers about goods or services “passively.” By passively we mean the consumer is not required to act in order to learn more about the value proposition within the ad, other than to pay attention to the ad itself. The “call-to-action” that some television based advertisements employ asks that the consumers call a 1-800 number or go to a web site in order to get more information. In either case the consumer needs to act as the ‘bridge’ to go source the information they are interested in using the preferred medium offered by the ad.

The ‘passive’ TV advertising model has been augmented in recent years by In-video Advertising (IVA)’ and ‘interactive TV (ITV).’ In both IVA and ITV, capabilities have been included that allow the consumer to ‘proactively request’ more information regarding a good or service offered in an advertisement or placed within a scene in a TV show or movie. The additional information is most often delivered directly to the same device (the TV set or computer screen for example) that it has been requested from or it is delivered to the consumer manually in the mail in an envelope using the account information for the consumer which is first made available by the provider of the TV service to the advertiser.

Companies that advertise products to consumers through any type of video content have always looked for multiple ways of getting their message across to the viewer in order to generate revenue from their products. Revenue is normally generated from the sale of goods or services to the viewer.

Advertisers typically promote their goods and services within video content in one of two ways. The first is a commercial segment, typically 30-seconds in duration, and the second method is via product placement within a video program.

As an example of a 30-second commercial segment, the advertiser targets the audience with a specific message in the hope that the viewer of the product will respond to a call-to-action or consider making a purchase at the point-of-sale by consciously or subconsciously recalling the advertisers brand, typically at a later date, time and location.

As an example of product placement within a video program, the advertiser typically has their product prominently displayed in an appropriate location within the scene of the show. The advertiser would hope that the association of the product with the show would be a subconscious trigger for the viewer to purchase their brand of product when making a point-of-sale transaction, typically at a later date, time and location.

The problem of advertising with these methods is that the advertiser only gets to promote their product at the time the video is being viewed. They have no way of continuing with the promotion once the commercial has ended, or the product placement segment has finished. Another problem is that the advertiser is very limited in the scope of what can be presented, primarily as a result of time constraints of the commercial segment, or the ability to influence product placement within a television show.

The prior art includes efforts to solve some of these problems.

There are examples of television commercials that include viewer-visible cues contained within the video that prompt the viewer to request more information. The viewer is able to respond to the cue by invoking a response wherein the viewer is either presented with additional information on-screen, or the viewer's information is sent to the advertiser for follow up. There are a number of problems with these approaches.

One problem with the existing efforts to solve the problem is that the content being displayed on-screen is distracting to the overall enjoyment of the show being watched. As a result the viewer is less-likely to interact with the information.

Another problem with the existing efforts to solve the problem is that the information typically only remains for as long as the program is being broadcast. In a typical 30-second commercial segment this would preclude the advertiser from offering much more promotional content than is available in the commercial itself.

Another problem with the existing efforts to solve the problem is that the advertiser has no real method for engaging in further contact with the viewer unless they immediately respond to the on-screen call to action, for example by dialing a special phone number “within the next few minutes.”

Another problem with the existing efforts to solve the problem is that the advertiser has no other way of making their brand a consideration at the point-of-sale unless the sub-conscious mind recalls the promotional content in some fashion.

U.S. Pat. No. 7,110,714B1 “Television commerce system with program identifiers” (Kay, Matthew W. Jul. 27, 1999) discloses in the abstract “A commerce control network is provided for obtaining product information and for purchasing products through a two-way interactive broadcast distribution system, such as a cable or satellite television system. The network includes advanced television set top boxes that provide users with the ability to access product information through the system. A unique identifier is received with the program being viewed and included in the user's request for product information to assure that the information retrieved from the network is timely and related to that program.”

The Kay patent refers to a cable broadcast delivery system in which a viewer can interact with content on television allowing the user to purchase goods or consume more informational content at the time the video is being watched. When the user requests more information, that information is retrieved from a relational database, formatted to be displayed within the limitations of a television set-top-box and then transmitted back over the cable broadcast system to be displayed on the viewers television.

The Kay patent is not able to discern the specifics of “what” is on screen at a given moment in time, thereby forcing the application to present “everything” that is available within the video feed. This forces the user to select what information they want to see from a potentially large list of items. The Kay patent requires the use of the cable provider's customer database to make point-of-sale purchases at the time the user is watching the program.

U.S. Pat. No. 7,430,753B2 “Method to enable cooperative processing and resource sharing between set-top boxes, personal computers and local devices (Gray, James H Mar. 27, 2002) discloses in the abstract “A system and method for resource sharing are provided. The method includes storing an electronic programming guide (EPG) application and an EPG, determining when local memory of a local video device lacks capacity to download additional time of the EPG, and communicating with another device to transmit a resource request to the other device to download the additional time of the EPG to storage in the other device. The method also includes processing for display monitoring data that indicates remaining storage space in the storage of the other device, querying the other device to determine what programming is being viewed, and processing controls included in the EPG application that enable access to the storage of the other device to interact with the EPG stored on the other device through the local video device to schedule a programming event at the local video device.”

The Gray patent enables devices on a local-area network the ability to stream or copy content between themselves as space is needed or if a user wishes to watch a different video feed on a device that could not either a) initially support the ability to play the content or b) did not initially have the content stored on it when the user wanted to watch it.

United States Patent 20020080161A1 “Network appliance for enhanced television services” (St. Maurice, Susan T. Jan. 27, 2002) discloses in the abstract “Enhanced television services are delivered and presented on a network appliance without the need for an enhanced-content enabled television set or set-top box. The enhanced content is decoupled from the television signal (or radio signal), allowing for the presentation of the enhanced content alone on a stand-alone network appliance. The network appliance may be a handheld computing device (e.g. a “palm” computing device), a tablette, a remote control with a display or a digital cellular phone handset with a display. The network appliance is enabled for Internet or Intranet access and is also provided with an infrared transmitter so as to operate as a remote control for a television (or radio) having an infrared beam receiver. Through use of the network appliance, the viewer would be presented with the same enhanced content on the network appliance as would be presented to the viewer if an enhanced content enabled television or set-top box (or radio) were being used.”

The St. Maurice patent replicates data from the set-top box interactive content and displays it on a hand-held device for consumption by the user. The information is replicated to the user by means of the user looking up the program and channel that they are watching and the appropriate content is returned to the handheld device. This process is similar to a user using a web-browser while watching television to go to a pre-determined web site and looking through content related to the show they are watching.

Further interactive television solutions only partially address advertisers needs and satisfy viewers interest in interactive content. Currently, interactive content may be distributed within an application sent to a set-top-box when a viewer tunes to a broadcast. The content is either completely distributed with the application or dynamically pulled by the application to the set-top-box when the user interacts with the application. This limits the scope of available content to the size of memory available to the application—either in total if all content is bundled with the application or on an individual basis if pulled dynamically by the application. It further limits the viewing of interactive content to during specific parts of the broadcast, as once the broadcast moves beyond a region having interactive content access to that content is no longer available.

What is needed is an advertising method that allows the advertiser of the products or services to be more prominent at the time the viewer is making a point-of-sale purchase decision and for the viewer to be able to request information that is contextually relevant to what they are watching at any given moment in time.

### BRIEF SUMMARY OF THE INVENTION

Platform Shifted Advertising (PSA) is a new approach, technology and value proposition for advertisers, video content owners and consumers alike. PSA blends traditional video advertising together with the new field of electronic fulfillment along with predefined electronic consumer delivery preferences to ensure consumers are provided information from ads shown on television (for example) on their preferred consumption device. Consumption devices include but are not limited to a cell phone, an email account or a social network page such as Facebook or MySpace for themselves or others to review at a time of their choosing. The key differentiator between traditional broadcast advertising and PSA is that with PSA the “call to action” or “fulfillment” of the consumer's interest in a product or service is delivered to the preferred device or service of the consumer's choosing electronically and using pre-defined preferences stored on computer servers to which the consumer has submitted their preferences. In PSA the ‘bridge’ between the advertisement and the additional information the consumer wants is handled via a backend computer server which delivers the information proactively to the consumer's preferred consumption device using the consumers preferred medium and platform. This shifts consumption control to the consumer instead of the advertiser, thereby insuring that the consumer does not need to call a 1-800 number or go to a special web site of the advertiser's choosing in order to access the related information sought. The blending of traditional video advertising, with automated delivery preferences together with an electronic delivery mechanism which bridges the consumer's request from one platform (the TV ad for example) to delivery of related information on another platform (a cell phone for example) using the consumer's pre-configured delivery preferences is the meaning behind the term “Platform Shifted Advertising.”

The market in which Platform Shifted Advertising competes is that of traditional video advertising and fulfillment market. This market predominantly comprises the “30 second ads” which are broadcast by television network stations at intervals every few minutes interrupting the playback of the movie, TV show, or other video content being watched by a consumer. Platform Shifted Advertising is an advanced set of features which can enhance these 30 second ads. PSA can also function as part of “In-Video Advertising” during the playback of the movie, TV show, or other video without necessitating being a part of a 30 second ad. PSA can be delivered via traditional cable or satellite television as well as newer internet delivered television.

The problem that needs to be overcome in order to make PSA work is that of providing a data “bridge” between the existing broadcast signal and an information service which also stores the PSA consumer preferences. A server with database storage may store the consumer's unique set-top box identification along with their preferred methods of data distribution. Additionally, a method of indexing video content enables providing specific “offerings” or “promotions” to consumers at the relevant points during a video broadcast.

The concatenation of the video index of what portion of video is currently playing to the unique ID of a consumer's set-top box or other playing device in order to look up specific preferences from a database along with the information the consumer wants from a separate database and finally sending it to the consumer's preferred consumption platform (cell phone, email, social network etc) is the application and technical challenge that has been overcome with this invention.

The viewer of video may respond to an on-screen event and have information about the relevant on-screen content delivered to a destination device for consumption at a later date, time and/or physical location. Moreover, the information delivered to the device may encompass, but is not limited to, more information about a product or service, a promotional call-to-action to purchase goods or services, embedded video, audio or other digital media to further promote the goods or service, links or contact information to other digital media, and/or coupons for use at point-of-sale locations.

A viewer of a movie, television program, television commercial or other video media may be informed via an on-screen display that there is more information available about product placement content, the product or service being offered (as in a television commercial), or the video content itself. This on-screen-notification may instruct the consumer to perform an action using their remote-control, or other remote-device, which may tell the consumer what information is available for delivery.

If the consumer was not already registered with the application, the consumer may be presented with either an on-screen registration process through the playing device or a registration process on a remote device.

Upon completion of registration, or if already registered, the consumer may be presented with the option of choosing a consumption device, such as mobile phone or social network, where they would like the data to be delivered. Alternative to selection, the consumer may pre-configure a default consumption device and select automatic delivery to bypass the need to select a device on selection.

Once the consumer has chosen the delivery device, the promotional or informational content may be delivered to that device for consumption at a later date, time and/or physical location.

### FEATURES AND ADVANTAGES

The invention provides a method for alerting the viewer of a movie, television program, commercial or any other video feed with a visual cue that there is more information available about the content currently on-screen.

The invention provides a mechanism for the viewer to register their contact details and create a user profile that can later be referenced for ease of sending information to said viewer. By registering their contact details, a viewer can quickly request more information without the need to register for the information every time.

The invention provides for multiple profiles to be available on any viewing capable device so that a consumer can select an appropriate profile to utilize that profile's settings. By utilizing profiles, multiple viewers within the same household can store delivery preferences independent of other household members. In addition, viewers can request different information be sent to different profiles, thereby eliminating instances where one profile, such as a parent profile, would get inundated with content requested by another viewer, such as a teenage child.

The invention correlates promotional or other informational meta-data or other digital content with the specific point in a video feed that the viewer has selected in order that the viewer can receive further information about the content displayed in the video feed. By tying the meta-data to the specific point in the video feed, the invention allows the consumer to get an accurate representation of only what is on-screen at the point they interact with the video.

The invention provides a mechanism for the consumer to save information about a device or multiple devices that they would like promotional or other informational meta data to be delivered to at a later date, time and/or physical location. By saving device information, consumers do not need to re-enter their delivery methods every time they interact with the invention.

The invention provides a mechanism for the consumer to select how and where they would like the promotional or other informational meta-data or digital content to be sent for consumption at a later date, time and/or physical location. The ability to select which device the information is delivered to based upon the consumer's preference at the time of viewing the information available frees the consumer to select the device that most fits their consumption of the meta-data/digital content.

The invention provides a mechanism to deliver the promotional or other informational meta-data or digital content to a chosen device for use at a later date, time and/or physical location. Because the informational meta-data is typically more valuable to the consumer at a point and place in time other than when the promotional content appears on-screen, the meta-data or other promotional content is delivered to the consumer's chosen device as opposed to being displayed on the television that the consumer is currently watching.

Instead of relying solely upon the viewer to respond to a call-to-action, such as calling a free phone number, or relying upon the sub-conscious mind to recall an advertisers promotional content or brand when at the point-of-sale, advertisers are better served by having their promotional content available to viewers of the program on-demand, after the viewing session has finished. This invention brings this and other benefits to advertisers. The advertiser or promoter of the informational content determines what message to convey to the consumer and what additional content or promotional material to provide if a consumer elects to request more information. The consumer is in control of initiating the request for more information as and when they see something of interest on-screen. The consumer has the ability to select what device to send the information to and what information they would like to have sent to that device. The consumer has the ability to retrieve the information sent to them on the appropriate device as and when they need it, including, but not limited to, a mobile device that can be used at the point-of-sale of goods or service, regardless of where the consumer is at that time.

### BRIEF DESCRIPTION OF THE DRAWINGS

In the drawings, closely related figures and items have the same number but different alphabetic suffixes. Processes, states, statuses, and databases are named for their respective functions.

FIG. 1 is a topographical layout that shows how devices interact with meta-data.

FIG. 2 is a flow diagram that details where the platform shifting takes place.

FIG. 3 shows a broadcast screen with an overlaid icon indicating content is available

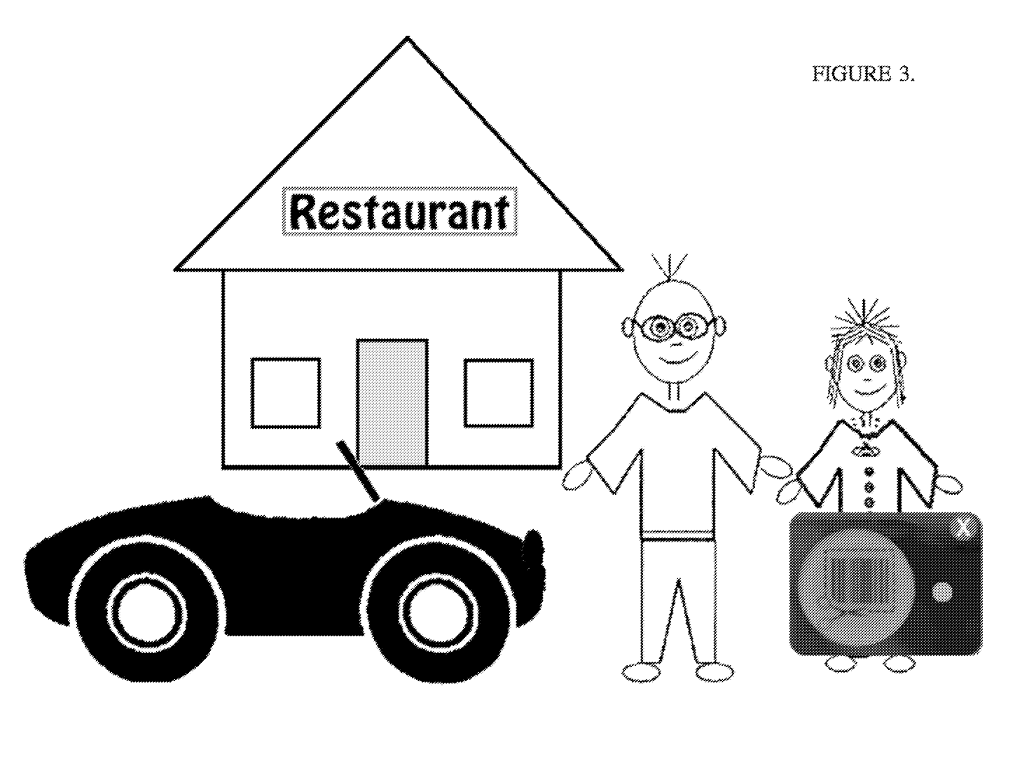

FIG. 4 shows a broadcast screen after action is taken while the interactive content icon is displayed, with desired destination choices displayed.

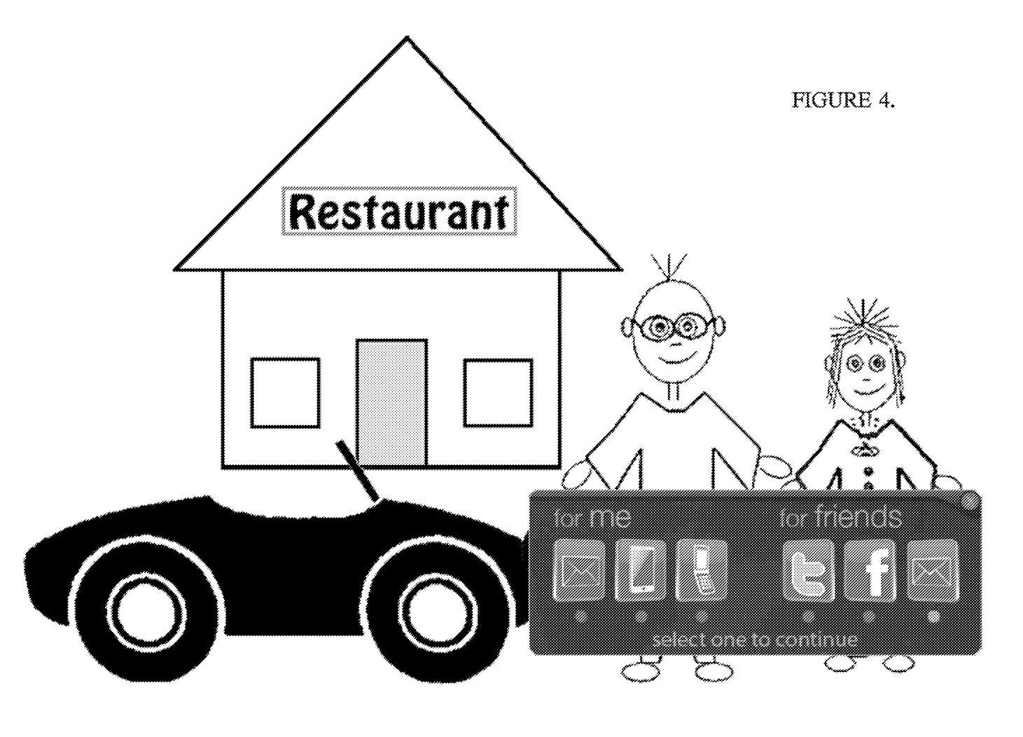

FIG. 5 shows a broadcast screen after action is taken while the interactive content icon is displayed, with specific friends destination choices displayed.

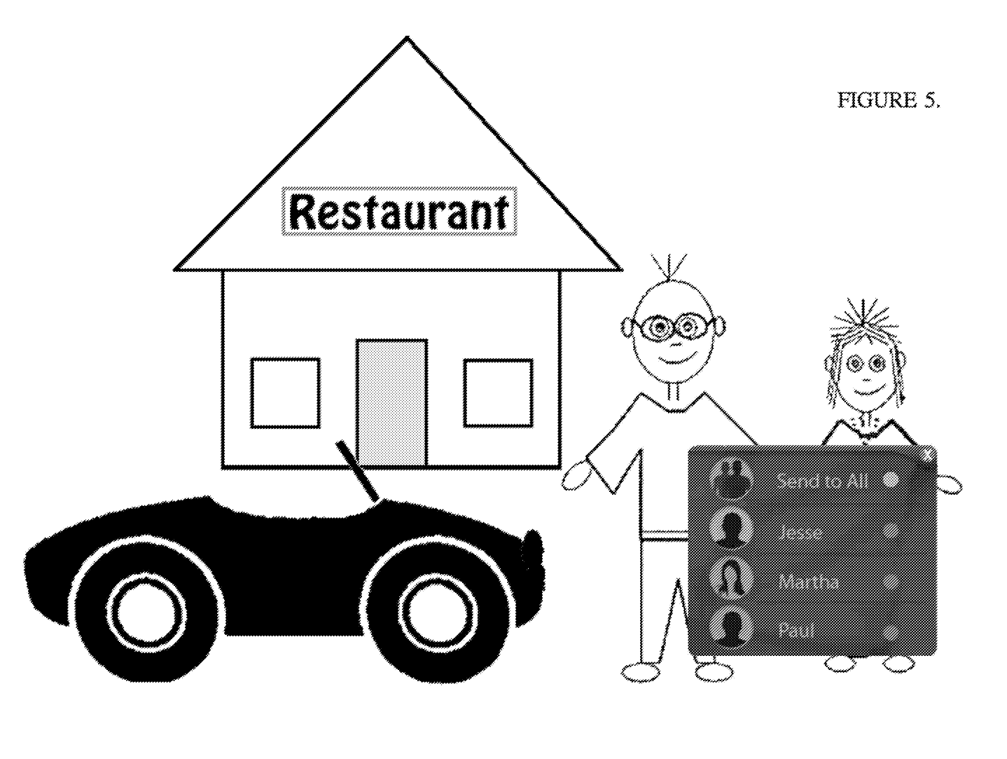

FIG. 6 shows a flowchart of interaction that occurs in sending interactive content to a destination.

### DETAILED DESCRIPTION OF THE INVENTION, INCLUDING THE PREFERRED EMBODIMENT

### Terminology

The terminology and definitions of the prior art are not necessarily consistent with the terminology and definitions of the current invention. Where there is a conflict, the following definitions apply.

A “consumer,” or “viewer,” is an individual watching a video to whom promotional or informational content such as advertising may be directed.

A “consumption device” is any device or platform configured to receive and display promotional digital content for a consumer. Examples include, but are not limited to, a tablet-computer (such as an iPad), smartphone or a text-message-capable mobile phone, email account, or social network such as Facebook capable of display on a computer.

A “consumption device profile” is stored in a database. The device profile may contain specific information about a consumption device, such as make, model, software version, serial number, access method, etc., but minimally contains a unique identifying consumption device profile key.

A “location marker” is a unique valued key that relates to a specific index location within a video file. The specific location can refer to a time-code, frame-number, the time from the start of the video content or any time-based metaphor that may identify a specific moment in time within a video file.

A “playing device” is the hardware controlling playback of video to a consumer. Examples of a playing device include, but are not limited to, a cable set-top-box, an internet-enabled television, a computer, or a tablet-based device such as an iPad.

“Promotional content” is additional informational or advertising material to be delivered to a consumer. Promotional content may be digital media files or other digital metadata, and relevant to at least one specific scene or segment of a video.

A “user profile” is stored in a database and can contain demographic information about a consumer, such as a name, address, phone number etc, but minimally contains a unique identifying user profile key.

A “playing device profile” is stored in a database and can contain specific information about the playing device, such as type of device, make, model, serial number etc, but minimally contains a unique identifying playing device profile key.

### Operation

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

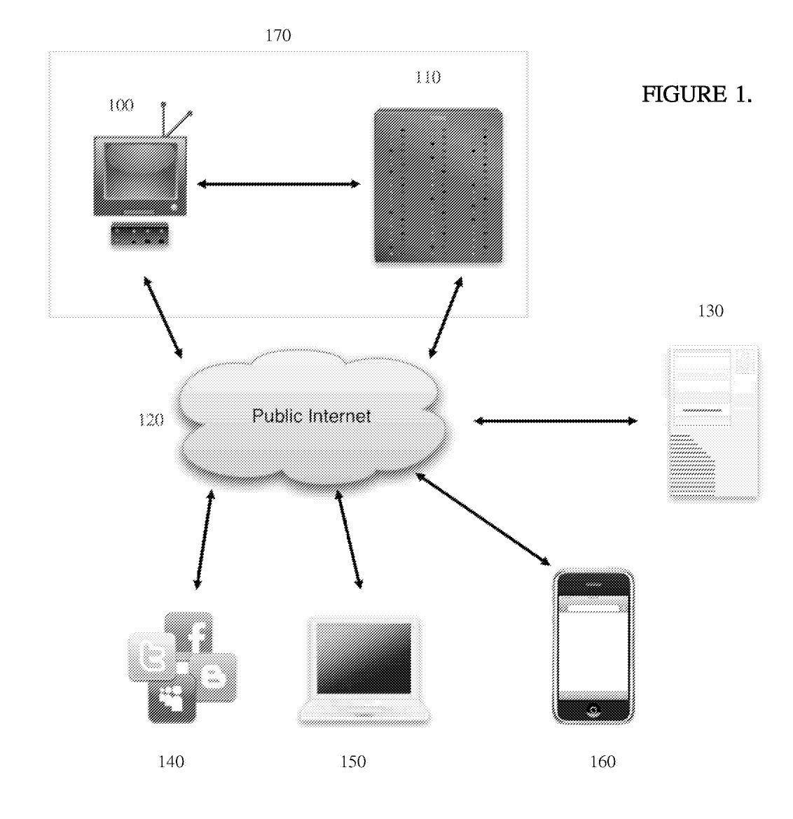

Referring to FIG. 1, a television program signal is delivered to interactive capable television, set-top box (STB), or other playing device 100 via a typical broadcast network. In a traditional cable television scenario this would be via head-end 110 delivery over a cable network to consumer's playing device 100. In a satellite scenario head-end 110 would broadcast the signal to a satellite that would be received by a satellite receiver a decoded to playing device 100. In an over-the-air (OTA) scenario the signal would be broadcast from television broadcaster 110 over the public airwaves and would be received by playing device 100.

In an embodiment of the present invention, a client application running on the playing device, such as consumer's STB 100, may start when either the playing device starts and allows the client application to load or the client application may start when it is received as an embedded application within the program stream being delivered from head-end 110.

When the client application starts it may verify the playing device's unique identifier with database 130 to see if the consumer has an account registered in the database. Database 130 may be any type of database, typically a relational database, stored or accessed through one or more servers such as cloud computing servers. A program running on the database server may enable data access through an API accessible through client applications running on the STB or through a web interface accessed through an Internet browser. The client application running on the playing device may communicate with the database in one of many possible methods depending upon the configuration and capability of playing device 100.

In one communication method, the client application may communicate using Internet standard protocols from client playing device 100 via broadcast head-end 110 across Internet 120 and to database 130. The return path for communication from database 130 may be via a standard Internet protocol through Internet 120 to head-end 110 where it may be forwarded to the client application running on playing device 100.

In another communication method, the client application may communicate using internet standard protocols from playing device 100 directly to Internet 120, thus bypassing broadcast head-end 110, and from Internet 120 to database 130. The return path for communication from database 130 to Internet 120 and back to the client application running on playing device 100 would be the reverse flow of the outbound direction.

In a variation of the prior steps, the communication may use a combination of either or both inbound and outbound communication flows.

During the life cycle of the client application running on consumer's playing device 100, the client application periodically checks to see if there is interactive content available for the program being consumed by the playing device. If interactive content is available the consumer is presented with an on-screen “bug” or icon that indicates to the consumer that content is a) available and b) may provide brief instructions on how to interact with the content.

The client application includes an index of all scenes in the current program. The index, as downloaded with the application or through periodic update, includes “on” or “off” information. The “on” or “off” information, or location markers, trigger the on-screen bug, or removes such bug, as appropriate. “On” or “off” markers may be tied to any matter related to the program. For example, they may represent the start and end of a music score, of a scene in a particular location, or of a particular item coming into view and then leaving view. The application does not need to know anything specific about the program or include any interactive content beyond the index and instructions on how to respond to actions taken while the “bug” is visible. This creates a very small space required by the client application, as no interactive content specific to any part of the program, such as program-related text or images, needs to be downloaded with the index.

All location markers may be stored in the database for packaging into appropriate applications for different playing devices and distribution media. Within the database, each location marker may identify a specific location within a video program. Such identification may be by a time-code, a frame number, or an elapsed time from the beginning of the video content. Each location marker may be stored in the database with a cross-reference to video title meta data, such as name of the video, owner of the video, and a description of the video. Also stored in the database for each “on” location marker may be a reference to an interactive media file. Interactive media files may be digital files such as, but not limited to, video files, audio files, still images, or text in various formats such as raw text or html files. Such interactive media files may be stored on the server or on other network accessible storage. Reference in the database to an interactive media file may be through a unique identifying key used to reference associated metadata. The associated metadata may include information about the digital file, such as location and how to access, as well descriptive details such as, but not limited to, advertiser information, description, and promotional pricing information.

In order to store location markers with references to video titles and interactive media files in the database, an authoring tool may be used. Such tool may be web-based in a browser or run as a separate application. An author or authorized user creating associations between the video and promotional material may run an application which allows playing or scrolling through the video. At any point, the author may mark the video to activate a bug (or to deactivate a bug if one is currently active). Such marking creates an “on” or “off” location marker given the current timestamp or playback position in the video, and associates the location marker with the video title. For “on” markers the author may, either during creation of the markers or in a review mode after creation, associate the marker with an interactive media file. The interactive media file may be a new file specific for that location marker or an interactive media file already referenced with another marker, thereby linking the same content to multiple scenes in the video. The author may additionally enter or edit descriptive data about such interactive media file if desired. The authoring tool may update the marker information and interactive media information directly into the database, or provide a method to export such data for separate import into the database.

In order to present the option of interactive content to consumers, the location markers are combined with the video in a standards-compliant self-contained digital package that allows for distribution over a cable network, satellite infrastructure, or through the Internet. To create such digital packages, a packaging program is run. The packaging program may read the video content into computer memory, create a second stream matching the length in time of video, and insert “on” and “off∞ location markers into the second stream based on the location markers stored in the database. For subsequent identification, video title information may be optionally be embedded into the stream. Once the second stream has been completed, the packaging program may bundle both video and the second stream into a specific video package for a delivery platform such as cable, satellite, or Internet. For example, the video package for cable or satellite may be an EBIF bound application that contains the video as well as a corresponding EBIF data-stream containing trigger information corresponding to the location markers. An example video package for an Internet video may be an MPEG-4 video stream with an MPEG-4 data stream containing index markers at the appropriate locations corresponding to the video.

The client application may read the location index markers from the video package and trigger display of an on-screen bug when appropriate. The specific method of displaying the on-screen bug may vary based on individual playing devices and the specific programming API for each device.

When the consumer interacts with the content, such as by clicking an OK or action button on a remote, the client application running on the playing device checks with database 130 to see if the consumer has previously registered.

If the consumer has not previously registered the client application presents a series of on-screen dialog boxes that allows the consumer to register as a consumer of the interactive application. The consumer's individual information is sent, along with the unique identifier of playing device 100, to database 130 where it is stored for future access. On initial registration, configuration of a default consumption device is required. Configuration of additional consumption devices may be triggered through the client application or by accessing a website to update account settings tracked in the database.

If the consumer is already registered or has just registered, the client application running on playing device 100 communicates with database 130 and provides a unique identifying string of characters and numbers that denotes the actual program, the current playhead location of the program, elapsed time since the program commenced, and the consumer's unique identifying information. Playhead location based on elapsed time allows for the same actions to be taken with both live and recorded programs. Database 130 returns to playing device 100 enough information to present the consumer with a choice about which device, such as computer 150 or mobile phone 160, and/or social network 140 they would like the content sent to, and what type of content they would like to send. If a default consumption device has been configured and an automatic delivery preference set, choice about end destination may be skipped and content delivered automatically.

The server packages the interactive media file associated with the location marker for delivery to the consumer's consumption device. Modification may be necessary based on the end device. For example, a device only capable of receiving a text message may have text or descriptive metadata sent to the device, with a link included if the interactive media file contains video, audio, or images, while a device capable of video playback may receive the interactive media file in a format capable of direct display on the device. Once packaged appropriately, the interactive media file may be sent across the Internet or other delivery method using standard protocols relevant to the receiving device or platform. An acknowledgement of the action may be sent to the consumer's playing device for display on-screen to the consumer.

The consumption devices could be any device capable of consuming content via an internet connection—whether it be direct or indirect. This would include mobile phones, smart-phones, tablet computers, laptop PC's or any other device capable of consuming the data. Consumption devices that are passive receivers, such as email accounts, social networks such as Facebook or Twitter, or cell phone SMS platforms receive shifted content within their regular programs, such as an email client or web browser. Other consumption devices, such as smart-phones, may operate a dedicated application program to directly receive shifted content. Content is typically delivered in the form of an digital media file or URL link back to another web page, although content may also be directly delivered in device-specific format to consumption devices running dedicated application programs.

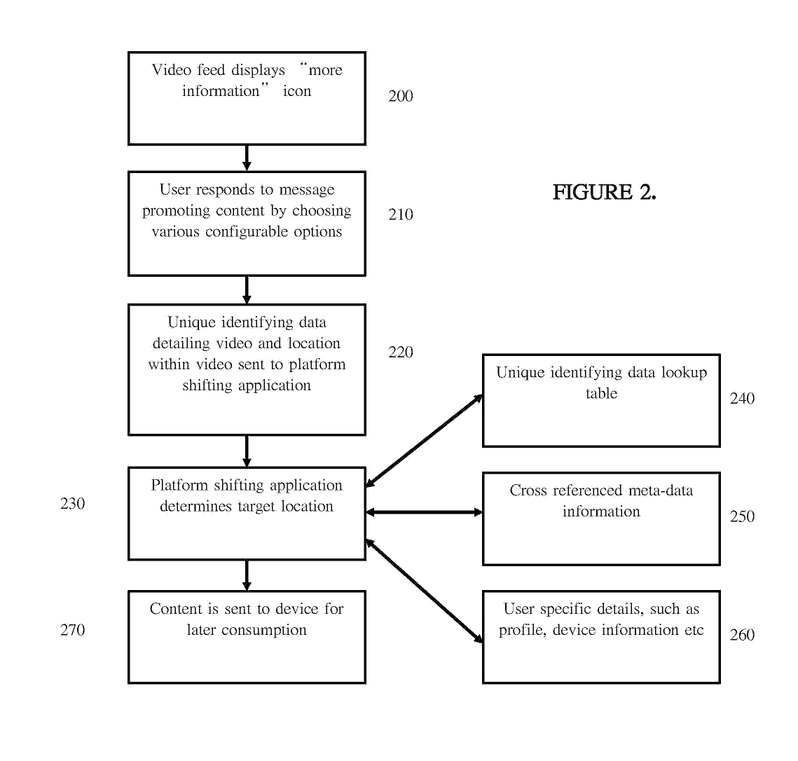

Referring also to FIG. 2, a “more information icon” displayed 200 could be any visual cue to prompt the consumer that more detailed information is available from the specific video feed being watched. This icon may be displayed as part of the client application running on playing device 100 utilizing industry open standard cable specifications such as the Enhanced Binary TV Interchange Format (EBIF) or the Open Cable Application Platform (OCAP). Alternatively the more information icon could be encoded into the video stream itself or it could be included as a transport stream within industry standard video codecs such as MPEG-4.

The consumer may respond 210 to messages using a remote control linked to the playing device or using a dedicated client application running on a consumption device. The consumption device application can be written in any programming language the device supports, such as C++, Objective-C, Java and Visual Basic.

Once the consumer responds, a unique identifying string of characters may be sent 220 to the platform shifting application. The unique string of characters may be constructed in a number of ways, but it will always identify the video program being watched and the specific location of the playhead. Examples of construction include a) utilizing a unique identifying key that is associated with the video when the video is indexed; b) using a federally mandated program identifier and the amount of time since the playhead started playing in the program being watched; or c) any other method that provides program specific identifiers and location specific identifiers.

The database may determine 230 the content that has been requested based upon the information sent to it and the available cross-referenced 250 promotional or other informational content. A server-side application may then format the information for delivery based upon the consumer's desired device delivery mechanism and preferences 260.

The information is delivered 270 to the consumption device using industry standard communication protocols specific to that device. Examples of industry standard communication protocols would be HTTP, HTTPS, SMS, MMS, IMAP, POP3 and SMTP.

To expand further, the consumption devices themselves can have specific applications written for them that can consume and use the content as it is delivered from database 130. For example, an iPhone might have a specific client application written for it that allows the consumption of the data so that it is presented in a coupon fashion that could be redeemed at the point-of-sale of the goods in the content.

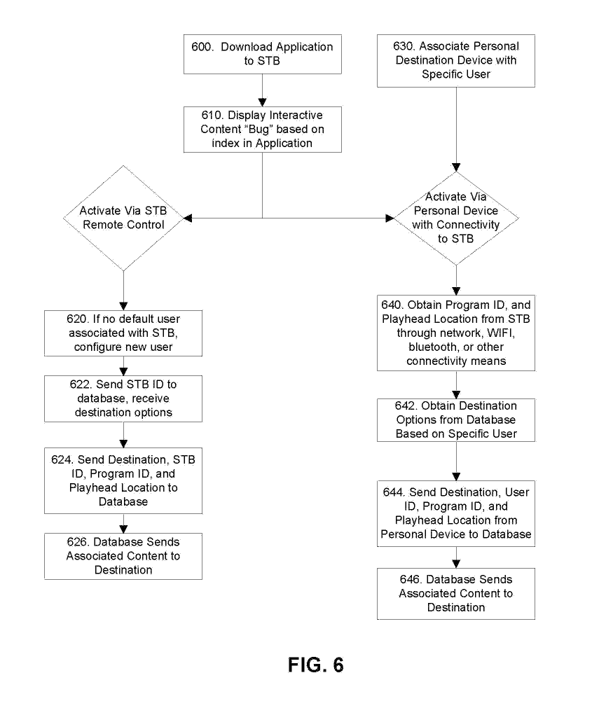

Referring also to FIG. 6, an alternative to using a set-top-box remote control is use of the consumption device to act as a request interface with the database and trigger the request for more information. This allows multiple viewers to request content while watching a video feed without interrupting the watching experiences of other viewers in the room. For consumption devices to trigger the request, the consumption device needs to obtain the playing device information including device identifier, program identifier, and current playhead position. Such information may be exchanged via network or bluetooth communications if supported by the playing device. As the consumption device may be configured for an individual consumer (or selected dynamically if configured for multiple consumers), the consumption device may then send the required information to the database to trigger the request without interfering with the displayed program on the playing device. The consumption device may request information directly to itself, or, through an application acting in similar fashion to the client application on the playing device, request information sent to any destination configured for that consumer. This creates a triangular communication configuration. The database sends the application including index markers to the playing device. The playing device tracks playhead location and delivers identification and location information to the consumption device. The consumption device interfaces with the database to request platform shifting and content delivery. Thus non-interruption of broadcast and multi-user platform shifting through a single playing device is enabled through use of the consumption device to interface with both the playing device and database.

### Other Embodiments

In another embodiment of the invention the consumption devices have dedicated client applications running on them that allow point-of-sale coupons to be redeemed electronically at a store. Once the promotional content or coupon has been delivered to the device, the consumer may redeem the coupon electronically at a store when making a purchase for the goods or services.

In another embodiment of the invention if the consumption devices have location based awareness built in (such as GPS or triangulation) they may present alerts to the consumer when the consumer is in the vicinity of locations related to specific content or advertisements delivered to the consumption device.

In another embodiment of the invention the consumption devices report back to the database how the consumer has used the promotional content or coupon. For example, each time the consumer looks at the promotional content, the consumption device may track and report back the date and time when the consumer reviewed the content.

Content may be input to the database by authorized users, such as authorized advertisers or production staff from the content or program provider. Content, once input, may be linked to a specific broadcast. Video broadcasts are indexed by scene, with indexing also mapped to playhead position. Markers may be added to specific indices to indicate context changes, such as an actor walking off screen, sunglasses or other products coming into view, musical score changes, or any other desired context change. Such markers are added with the appropriate cues to indicate interactive content availability. Once input and linked, shifted content is available to all viewers of that specific broadcast. As the shifted content is not tied to an application downloaded to a playing device but rather stored independently and identified by playhead location, shifted content avoids size restrictions and can be accessed at any time, rather than limited to playing device application size constraints and accessible only during specifically configured portions of the broadcast.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for delivering digital content associated with a video broadcast, comprising:
delivering an index from a computer server to a video playing device, the index having markers corresponding to a playing video;
displaying, on the playing device, a visible icon to indicate content is available based on markers in the index;
receiving an action command from a watcher of the video while an icon is visible;
sending, to the computer server, identification of the playing device and the playhead position of the playing video;
correlating, by the computer server, the playhead position with additional digital content; and
sending the additional digital content to a consumption device for viewing.

2. The method of claim 1, further comprising delivering, from the computer server to the playing device, a client application.

3. The method of claim 2, wherein the client application contains the index.

4. The method of claim 2, wherein the client application reads the index delivered separately from the computer server.

5. The method of claim 2, wherein the client application sends the identification of playhead position and playing device to the computer server.

6. The method of claim 2, wherein a consumption device communicates directly with the playing device to obtain identification of the playing device and playhead position of the playing video, and the consumption device sends such identification to the computer server upon receipt of an action command entered to the consumption device.

7. The method of claim 6, wherein multiple users use separate consumption devices to separately request additional digital content while watching the same video on the same playing device, thereby allowing multiple users to request and receive additional digital content without impacting the viewing experience of other users.

8. The method of claim 1, wherein the index contains on and off location markers corresponding to time or playback position within the playing video to display or stop display of the icon.

9. The method of claim 8, further comprising storing the on and off location markers in a database accessible by the computer server, allowing creation of multiple index formats for different video distribution methods to associate with the same markers and additional digital content.

10. The method of claim 8, wherein the playing video is a live streaming video.

11. The method of claim 8, wherein the playing video is a recorded video.

12. The method of claim 1, wherein receiving an action command triggers a user identification process which identifies a user registered with the computer server is associated with playing device, or creates a new user account if no such user is registered with the computer server.

13. The method of claim 12, further comprising selecting a consumption device after identifying a user.

14. The method of claim 13, wherein selecting a consumption device comprises the computer server selecting a consumption device associated with the registered user and marked as a default device.

15. The method of claim 13, wherein selecting a consumption device comprises presenting a list of consumption devices to the user for selection.

16. The method of claim 13, wherein the additional digital content includes a link a website.

17. The method of claim 3, wherein the additional digital content is an interactive media file accessible by the computer server.

18. The method of claim 17, further comprising processing the interactive media file by the computer server to a format displayable on the selected consumption device.

19. The method of claim 18, further comprising running a specific application on the consumption device to receive and display the interactive media file.

20. The method of claim 13, wherein the consumption device is either a specific hardware device or a computer software platform able to receive at least one form of digital content.
